(19) United States
(12) Patent Application Publication
(10) Pub. No.: US 2016/0381437 A1
(43) Pub. Date: Dec. 29, 2016

(54) LIBRARY STREAMING OF ADAPTED INTERACTIVE MEDIA CONTENT

(71) Applicant: Curious.com, Inc., Menlo Park, CA (US)

(72) Inventors: Justin Shelby Kitch, Palo Alto, CA (US); John Paul Tokash, Pacifica, CA (US); Thai Duc Bui, Los Altos, CA (US); Sadie Stoumen, Palo Alto, CA (US); Gordon McNaughton, Menlo Park, CA (US)

(73) Assignee: Curious.com, Inc., Menlo Park, CA (US)

(21) Appl. No.: 15/136,877

(22) Filed: Apr. 22, 2016

Related U.S. Application Data
(60) Provisional application No. 62/178,951, filed on Apr. 22, 2015.

(51) Int. Cl. H04N 21/8545; G11B 27/10; G11B 27/00; G11B 27/34; G11B 27/036; G09B 5/02; H04N 21/234; H04N 21/2668; H04N 21/262; H04N 21/431; H04N 21/845; H04N 21/854; G11B 27/034; H04N 21/81

(52) U.S. Cl. CPC H04N 21/8545; G11B 27/034; G11B 27/105; G11B 27/002; G11B 27/34; G11B 27/036; H04N 21/8133; H04N 21/23424; H04N 21/2668; H04N 21/26283; H04N 21/4312; H04N 21/8456; H04N 21/85406; G09B 5/02

(57) ABSTRACT

A data processing, computer-implemented method for library streaming of adapted interactive media content. The method includes receiving a first video content that has one or more video data files. The first video content is segmented into a plurality of time-coded sections, and each time-coded section corresponds to a section video data file that plays a key concept of the first video content. The method includes using multiple templates for multiple locations in a sequence of section video data files that are being configured for streaming, each one of the templates defining transition content layout for each one of a specific location in the sequence of section video data files. The method automatically loads transition data into each of templates for each specific one of the multiple locations in the sequence of the section video data files to generate transition content prior to or as streaming occurs.

### BACKGROUND

The present disclosure relates generally to data processing systems and method and more specifically to data processing systems and methods for video segmenting, editing and sequencing.

One fundamental human trait is our desire to continue learning. We might want to learn for personal reasons, for reasons related to work or for other reasons. As an example, a user might want to learn how to use the open computing platform Arduino or Raspberry Pi for coding. Or, a user might wish to take the course “Crochet for Beginners.”

Many such courses are selectable from video content libraries at www.curious.com, a website associated with the assignee of the present invention. The standard curious library includes many novel features including interactivity of its video-based content as discussed in Applicant's co-pending applications. It is often desirable to stream content from such video content libraries.

It is within the aforementioned context that a need for the present invention arises, and there is a need to address one or more of the foregoing disadvantages of conventional systems and methods, and the present invention meets this need.

### BRIEF SUMMARY

Various aspects of a media content and library streaming system and method can be found in exemplary embodiments of the present invention.

In a first embodiment, a data processing, computer-implemented method is disclosed. The method includes receiving a first video content that has one or more video data files, wherein the first video content is segmented into a plurality of time-coded sections, and wherein each respective time-coded section corresponds to a section video data file that plays a key concept of the first video content. The method includes using multiple templates for multiple locations in a sequence of section video data files that are being configured for streaming, each one of the templates defining transition content layout for each one of a specific location in the sequence of section video data files; and automatically loading transition data into each of templates for each specific one of the multiple locations in the sequence of the section video data files to generate transition content prior to or as streaming occurs.

In a further embodiment, the method includes generating a stream-able video sequence or file by merging the transition content and the section video data files. In another embodiment, the method includes automatically loading transition data into each of the templates via a script file including instructions to load transition data into each of the templates. In a further embodiment, the method also include using a first template for an introductory transition located before the first video content, the introductory transition comprising introductory data for the first video content. In another embodiment, the uses a second template for a testing transition located at the end of a time-coded section, the testing transition comprising data that tests concepts of the first video content.

In another embodiment, the method uses a third template for an outro transition located at the end of the first content, the outro transition comprising concluding credit data for the first video content. In another embodiment, the method receives a second video content that has one or more video data files, wherein the second video content is segmented into a plurality of time-coded sections, and wherein each respective time-coded section corresponds to a section video data file that plays a key concept of the second video content, and using a fourth template for an in-between first and second video content transition that is located between the first video content and the second video content, the in-between first and second video content transition comprising notification data for the upcoming second video content.

In yet another embodiment, a computer program product, encoded on a non-transitory computer-readable medium, operable to cause data processing apparatus to perform operations comprising: receiving a first video content that is comprised of one or more video data files, wherein the first video content is segmented into a plurality of time-coded sections, and wherein each respective time-coded section corresponds to a section video data file that plays a key concept of the first video content, using a plurality of templates for multiple locations in a sequence of the plurality of section video data files that are being configured for streaming, each one of the plurality of templates defining transition content layout for each one of a specific location in the sequence of section video data files; and automatically loading transition data into each of the plurality of templates for each specific one of the multiple locations in the sequence of the plurality of section video data files to generate transition content prior to or as streaming occurs.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a video “TV” streaming communication network according to an exemplary embodiment of the present invention.

FIG. 2A is a screenshot of an interactive video lesson interface of a video lesson that is stored in a interactive video library of FIG. 1.

FIG. 2B is a screenshot of the interactive video lesson interface of FIG. 2A.

FIG. 3A is a screenshot of a streaming TV schedule interface according to an exemplary embodiment of the present invention.

FIG. 3B is a screenshot of a video lesson as it is streamed on a musicTV channel.

FIG. 4 illustrates components of the video “TV” streaming server system of FIG. 1 according to an exemplary embodiment of the present invention.

FIG. 5A, FIG. 5B, and FIG. 5C are screenshots of an animated intro transition that is positioned before a course to introduce that course in accordance with exemplary embodiments of the present invention.

FIG. 6A, FIG. 6B, FIG. 6C and FIG. 6D show an animated exercise transition that is configured for and positioned after a section (or time-coded section) of a video lesson has played.

FIG. 7 shows a screenshot of an animated lesson carousel transition according to an exemplary embodiment of the present invention.

FIG. 8 illustrates a screenshot of an animated course outro transition in accordance with an exemplary embodiment of the present invention.

### DETAILED DESCRIPTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

An example of a website for implementing the system and method of the present invention is locatable at www.curious.com. The term “website” is generally applicable to a method for downloading/uploading and should not be construed as being limited to content downloaded/uploaded via Internet or HTTP (HyperText Transmission Protocol). Note also that server-performed functionality can also be performed on the client side as well.

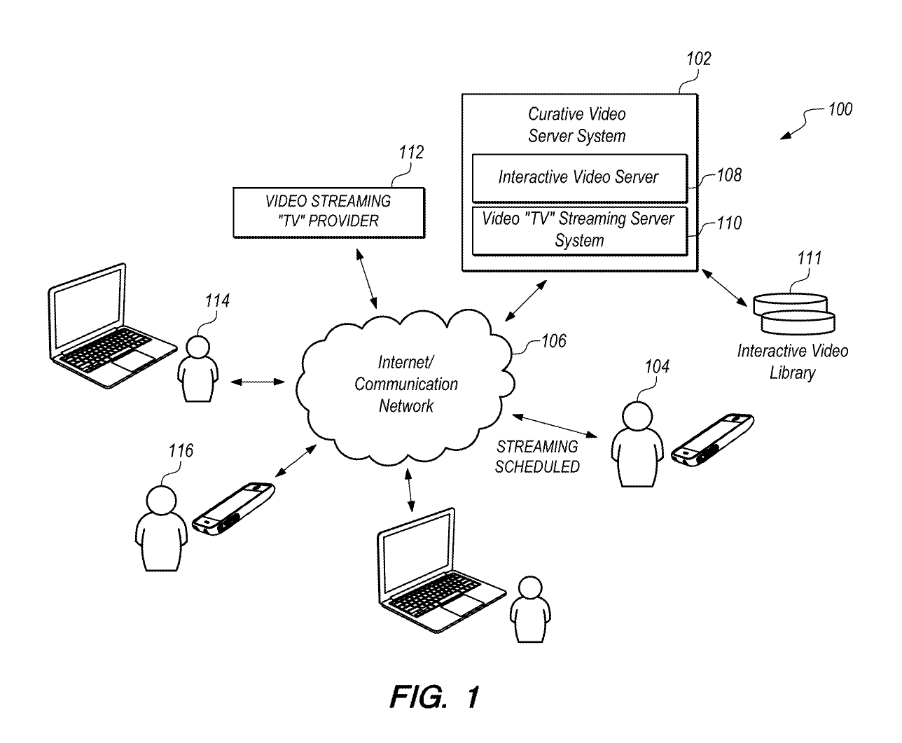

FIG. 1 illustrates video “TV” streaming communication network 100 according to an exemplary embodiment of the present invention.

In FIG. 1 and the entirety of this specification, the acronym “TV” is used to denote traditional television-like attributes. Here, among other components, video “TV” streaming communication network 100 comprises curative video server system 102 and mobile user 104 communicably coupled via Internet/communication network 106.

Internet/communication network 106 can be any network, wireless or wired whether direct or indirect that allows data communication from one point to another. Here, mobile user 104 is any user that wishes to become more proficient at a desired subject matter or who is simply curious about such subject matter. Mobile user 104 can use the mobile device shown to access curative video server system 102 to either access interactive and curated video-based content or to stream the content as adapted.

Specifically, curative video server system 102 uses its interactive video server 108 to provide curated interactive video-based learning on thousands of content ranging from “Beginning C++ Coding” to “How to Play the Guitar,” all of said content being stored in its interactive video library 111. The interactive video-based learning available at www.curious.com includes features and functionality like exercises, attachments, projects and comments that keep users engaged at all times.

Curative video server system 102 also uses video “TV” streaming server system 110 to stream the same content but in a non-interactive fashion. Specifically, video “TV” streaming server system 110 streams an uninterrupted and scheduled 24/7 non-interactive content version of the content stored in the video library.

The content may be streamed in conjunction with a video streaming provider 112. However, one skilled in the art will realize that other delivery mechanisms may be employed.

In FIG. 1, other components of video “TV” streaming communication network 100 include content creator 116 and content creator 118 as well as user 114 that might also use a computing device such as a laptop or desktop to access curative video server system 102. Content creators 116 and 118 may produce video content and impart knowledge about subject matter on which the content creators are skilled.

For example, content creator 118 might produce video content on “Python for Beginners.” As another example, content creator 116 may produce video-based content for “How to Play the Guitar.”

Although not shown, curative video server system 102 might include a lesson builder that curates video content received from content creator 116 and content creator 118 for distribution to users as further described with reference to co-pending application Ser. No. 13/965,151 entitled “Video Builder System and Method” and co-pending application Ser. No. 13/624,581 entitled “Embeddable Video Playing System and Method,” both of which are hereby incorporated by reference as if fully set forth herein.

In operation, mobile user 104 might access curative video server system 102 by pointing its browser URL to www.curious.com. Once access is obtained, mobile user 104 can view a streaming “TV” guide similar to a traditional television guide.

The streaming “TV” guide is a schedule of content that is to be streamed. In fact, mobile user 104 may browse the streaming “TV” schedule to determine which and when to watch content. As noted, video “TV” streaming server system 110 then streams content at scheduled times all day and offers a television experience similar to traditional television.

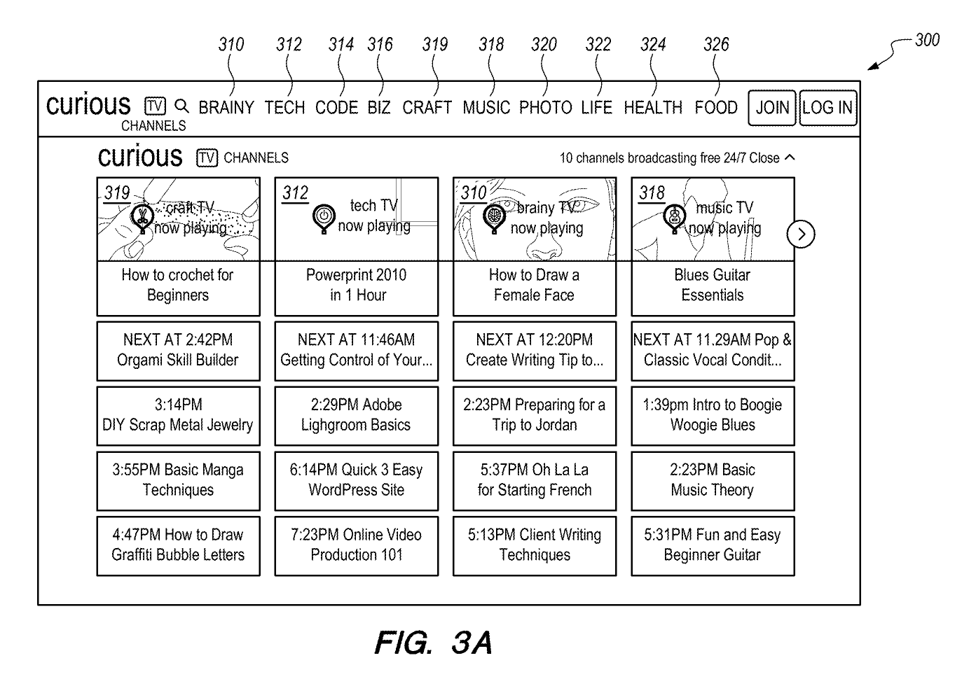

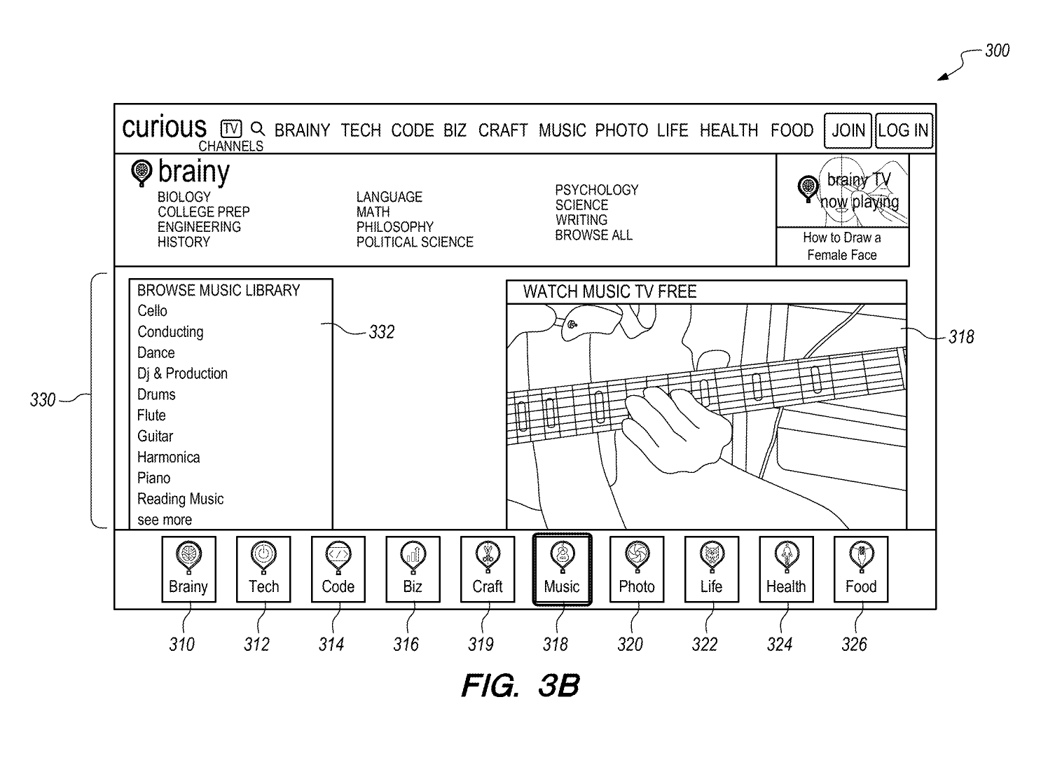

For example, mobile user 104 might be watching techTV channel 312 (see FIG. 3A) and might decide to stay on that channel all day for as long as desired. Mobile user 104 may also decide to switch to brainyTV channel 310 (see FIG. 3A as well). Streamed content emanates from interactive content stored in interactive video library 111. The content includes video data files for courses and lessons, each course, lesson or respective video data file being segmented into time-coded sections. Each time-coded section may correspond to a video data file that plays a key concept of the lesson or video content.

Unlike traditional TV, which does not have the concept of RSVP, the present invention allows mobile user 104 to RSVP and receive a reminder email prompt about the content. Although not shown, mobile user 104 might RSVP by selecting a future scheduled streaming video from the streaming “TV” guide after which the user is prompted to confirm the RSVP.

An advantage of the present invention is that all of the interactive video content in interactive video library 111 can be streamed to users as flat non-interactive video content. As will be further discussed, by using the methods of the present invention, thousands of courses and lessons can be canned from interactive video into non-interactive video content for streaming to users. An embodiment of the present invention makes it possible to automate the entire interactive video library content: large amounts of video content, lessons, folders, files or the like with interstitials and transitions between lessons, courses, breaks as the case may be.

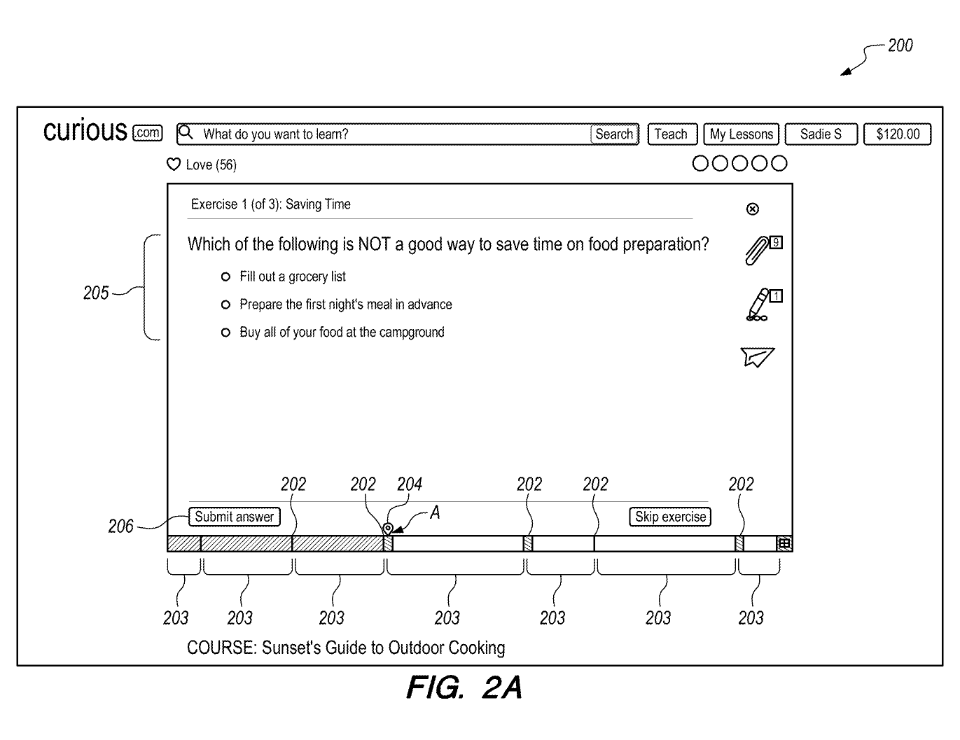

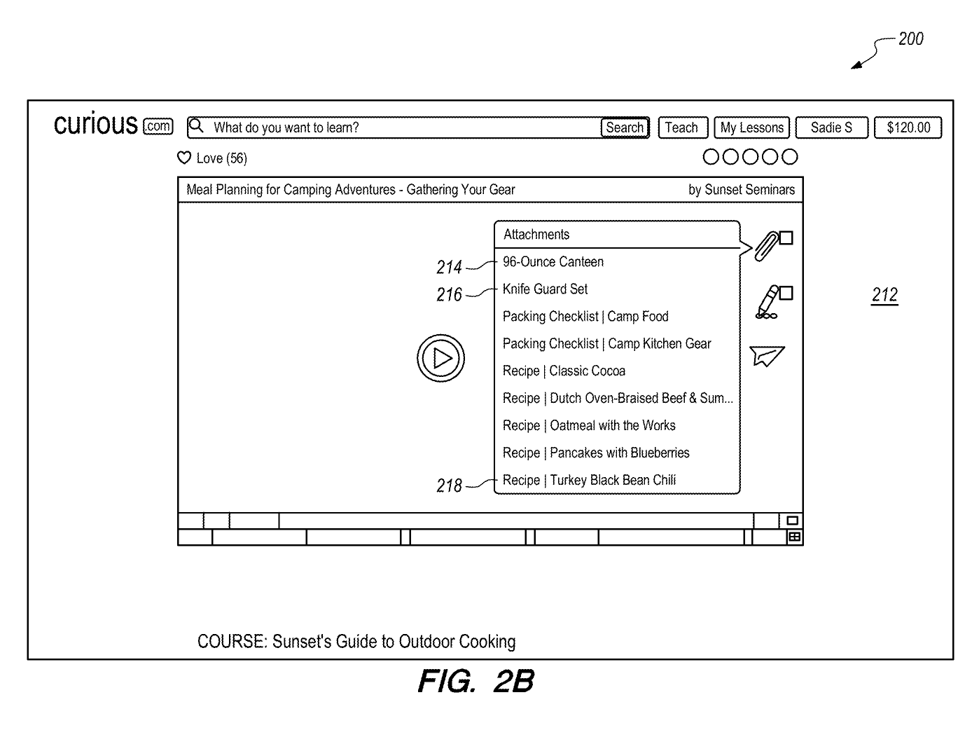

FIG. 2A is a screenshot of interactive video lesson interface 200 of a video lesson that is stored in interactive video library 111 of FIG. 1.

In FIG. 2A, interactive video lesson interface 200 comprises a plurality of section breaks 202 that indicate the end of a time-coded section 203. Section breaks 202 facilitate interactivity with mobile user 104 by pausing the video lesson when a section break is reached. At that point, a transition for the next lesson is displayed, or a quiz question can be displayed to which mobile user 104 may submit an answer. As an example, in FIG. 2A, the video lesson play head 204 has reached a section break 202 also indicated as point A in FIG. 2A. At this point, a quiz question 205 is displayed to which the user can respond. The user may select a submit button 206 to submit an answer after which the lesson proceeds to the next section.

FIG. 2B is a screenshot of the interactive video lesson interface 200 of FIG. 2A. Here, additional features that promote interactivity include attachments 212 and the ability to submit comments and questions (not shown) to a video lesson teacher. Attachment 212 can be any additional material beyond the lesson that is provided to users. As shown here, attachment 212 includes a list of items needed for meal planning on a camping adventure. As shown, the attachment 212 list includes 96 ounce canteen 214, knife guard set 216 and turkey black bean chili recipe 218.

### STREAMING

Media streaming or streaming is important for transferring data so it can be quickly processed as a continuous or steady stream. With streaming, mobile user 104's browser or plug-in can start to display data before the entirety of the file has been transmitted. Streaming can be valuable where a user does not have fast enough access to download large media files quickly. Streaming can also be a valuable technique for exposing users to an overwhelmingly large amount of content in a library that the users would otherwise not have access to, or in the case of free streaming, users can watch free streamed content before deciding whether to fully subscribe.

FIG. 3A is a screenshot of a streaming TV schedule interface 300 according to an exemplary embodiment of the present invention.

In FIG. 3A, streaming TV schedule interface 300 includes 10 channels that stream video content for a 24-hour duration. Specifically, these channels include brainyTV 310, techTV 312, codeTV 314, busTV 316, musicTV 318, craftTV 319, photoTV 320, lifeTV 322, healthTV 324, and foodTV 326. In this interface, a short schedule for craftTV 319, techTV 312, brainyTV 310 and musicTV 318 is also displayed.

As with traditional television, mobile user 104 can watch content that is playing now on any of the channels. The user can switch from craftTV 319 about “How to Crochet for Beginners” to “PowerPoint 2010 in One Hour” on techTV 312. Although not shown, the user may also RSVP by selecting an upcoming program on any of the channels. Upon selection of a scheduled program, a window displays for a user to confirm that the user wishes to RSVP for the program.

Upon confirmation, a reminder is sent to the user leading up to the event to remind the user to watch the scheduled event. As can be seen, on musicTV 318, the next scheduled video streaming event is at 11:29 a.m. for “Pop and Classical Vocal Conditioning” followed by “Intro to Boogie Woogie Blues Piano” at 1:38 p.m. followed by “Basic Music Theory” at 2:28 p.m. and “Fun and Easy Beginner Guitar” at 5:31 p.m. All of the content that is streamed is obtained by adapting interactive video content that is already present in the interactive video library 111. Interactive video library 111 contains thousands of interactive video content converted for streaming by video stream TV server 110 in conjunction with video streaming TV provider 112 of FIG. 1.

FIG. 3B is a screenshot of a video lesson as it is streamed on Music TV 318. Specifically, the video lesson is on Blues Guitar Essentials. As seen here, mobile user 104 has selected Music TV 318 but can also select any one of the other channels including Brainy TV 310, Tech TV 312, Code TV 314, Bus TV 316, Craft TV 319, Photo TV 320, Live TV 322, Health TV 324 or Food TV 326. As shown at 330, music library 332 having interactive video content can also be browsed as mobile user 104 receives streamed content from the channels.

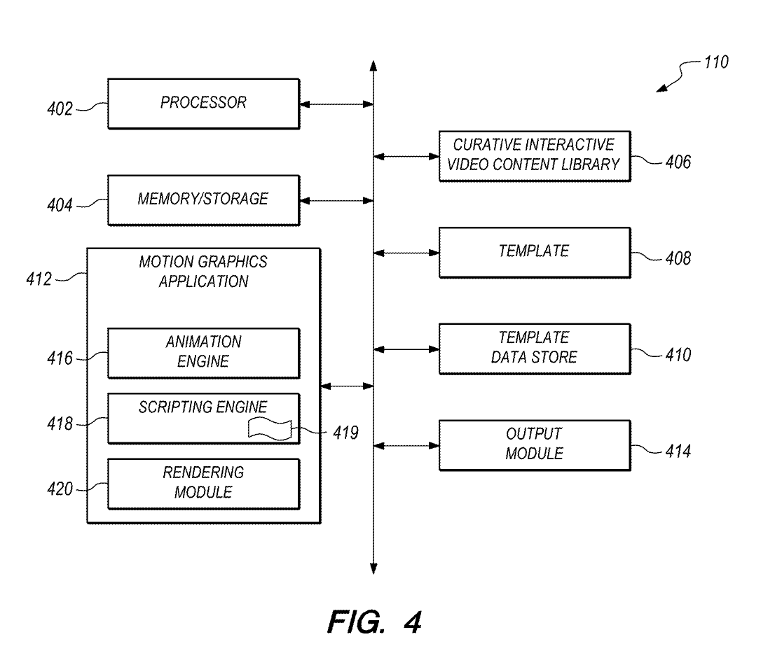

FIG. 4 illustrates components of video “TV” streaming server system 110 of FIG. 1 according to an exemplary embodiment of the present invention.

As previously noted, video “TV” streaming server system 110 in conjunction with video streaming TV provider 112 can stream free content on a 24/7 basis. This streaming can occur because the system adapts interactive video content stored in interactive video library 111.

In FIG. 4, video “TV” streaming server system 110 includes processor 402 as well as memory/storage 404 and curative interactive video content library 406. As used herein, curative interactive video content library 406 may be used interchangeably with interactive video library 111. Curative interactive video content library 406, as implied by its name, stores interactive video content that includes video content comprised of one or more video data files.

As used herein, content may refer to a video based course. A course may comprise one or more lessons. A lesson is typically comprised of a single video data file but can include two or more video data files that are combined into a single lesson. A course comprises two or more lessons in which case the course has at least two video data files, with the first data file being a first lesson and the second video data file corresponding to a second lesson.

Regardless of whether the course or lesson has a single video data file or multiple video data files, each course or lesson is segmented into time-coded sections that engage users for the entirety of the lesson by facilitating interactivity between users and the video lesson. A time-coded section is keyed to the particular sub-concept or sub-topic of the main lesson.

In FIG. 4, video “TV” streaming server system 110 further includes a template module 408, template data store 410, motion graphics application 412, and output module 414. Although not shown, template module 408 might be a database, a storage unit, or might be stored in memory/storage 404.

As implied by the name, template module 408 holds templates for transitions between the sequences of video data files. In one embodiment, the templates are animation templates. Each template has a blank slot for titles, videos, images, exercises, and exercise answers, etc. The slots are preconfigured to appear in certain places, use certain fonts, styles, and size. Each slot is given a unique name so that it is easily locatable. Template data store 410 holds transition data that is loaded into the templates stored in template module 408.

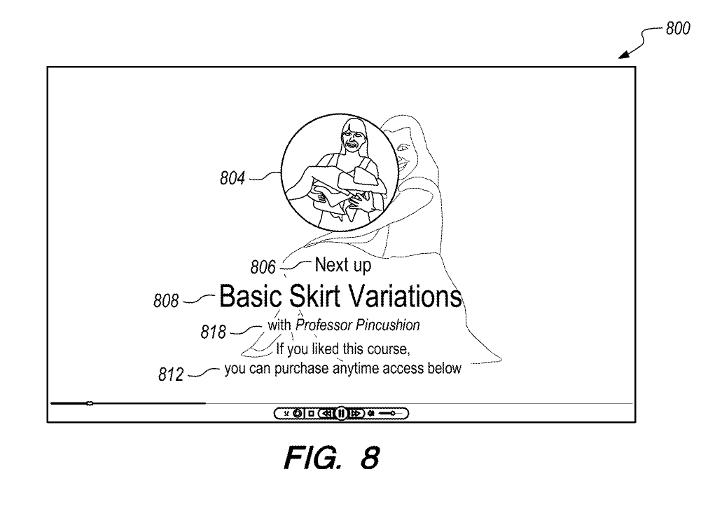

Only specific types of data may be loaded into particular templates. For example, for a course outro (see FIG. 8) for an end-of-course template, closing credits data or specific text such as “thank you for watching” may be loaded. In the present embodiment, there are five types of animation templates. First is an intro (course) template; second is a lesson transition template; third is a lesson section template; the fourth is an exercise (or quiz, testing) template, and the fifth is a course outro template.

In FIG. 4, template data store 410 may include metadata and files required for lessons. Data might include testing, exercises and answers for the exercises/quizzes/testing, titles, names of authors, and introductory and closing information data.

Motion graphics application 412 may include animation engine 416, scripting engine 418, and rendering module 420. Animation engine 416 animates the transition content that is obtained by loading template data into a template. Scripting engine 418 includes script file 419 that contains among others, instructions to read an intermediate data file stored by template data store 410 and to load said data into appropriate animation templates.

In one embodiment, script file 419 is written in JSX, Adobe's JavaScript language. One of ordinary skill in the art will realize that other languages within the principles and precepts of the present invention may be employed.

Script file 419 proceeds through a number of steps. First, as noted, script file 419 reads the intermediate data file stored by template data store 410.

To generate the intermediate data file, a connection tool may be used to connect to the curative video server system API to request metadata: a course, its author, and all lessons in the course. For each lesson in the course, the tool: picks a subset of exercises and answers that will look best in the video (one correct answer+several incorrect answers, preferring short answers that will fit on the video); then generates an intermediate data file (json) with the chosen subset of data; downloads media files required by the lesson (images and videos); takes clips of the beginning few seconds of video for each lesson, for use in the “carousel” lesson transition. In an embodiment, the metadata and intermediate data is based on JSON (JavaScript Object Notation) format for data exchange. The connection tool may be based on JRuby.

Next, script file 419 fills in the blank slots in the animation template with values from the data file. It may also resize images and videos as necessary to preserve aspect ratios. Script file 419 further generates the “carousel” lesson transition animation which is filled with video clips from the beginning of each lesson, and then clones the section template once for each section and fills in section-specific titles and videos.

Next, script file 419 clones the exercise template for each exercise and fills in questions/answers, video screenshot background; script file 419 clones the “outro”/credits and fills it in with author info and avatar image. Thereafter, script file 419 assembles a complete animation for each lesson using these pieces, and then passes the animations to rendering module 420.

Rendering module 420 combines all of the video images and transition content into a single flat file that can be streamed. In one embodiment, rendering module 420 may be AME (Adobe Media Encoder). Once a single flat file is created, that file is forwarded to output model 414 and/or to video streaming TV provider 112 for streaming to users such as mobile user 104 and user 114.

Although not shown, animation engine 416, scripting engine 418, and rendering module 420 may be separate components or application software. Motion graphics application 412 may be a software application such as Adobe After Effects available from Adobe Corporation of San Hose, Calif. One of ordinary skill in the art will realize that although not shown, FIG. 4 may include additional or fewer components that may or may not be integrated to accomplish the objectives of the present invention.

Scripting engine 418 executes script file 419 as noted. As can be seen, video TV streaming server system 110 uses templates for multiple locations in the sequence of video data files before the data files can be streamed. The data for the data files are automatically loaded by the script file 419 into the templates that are designated for particular locations in a sequence of video data files.

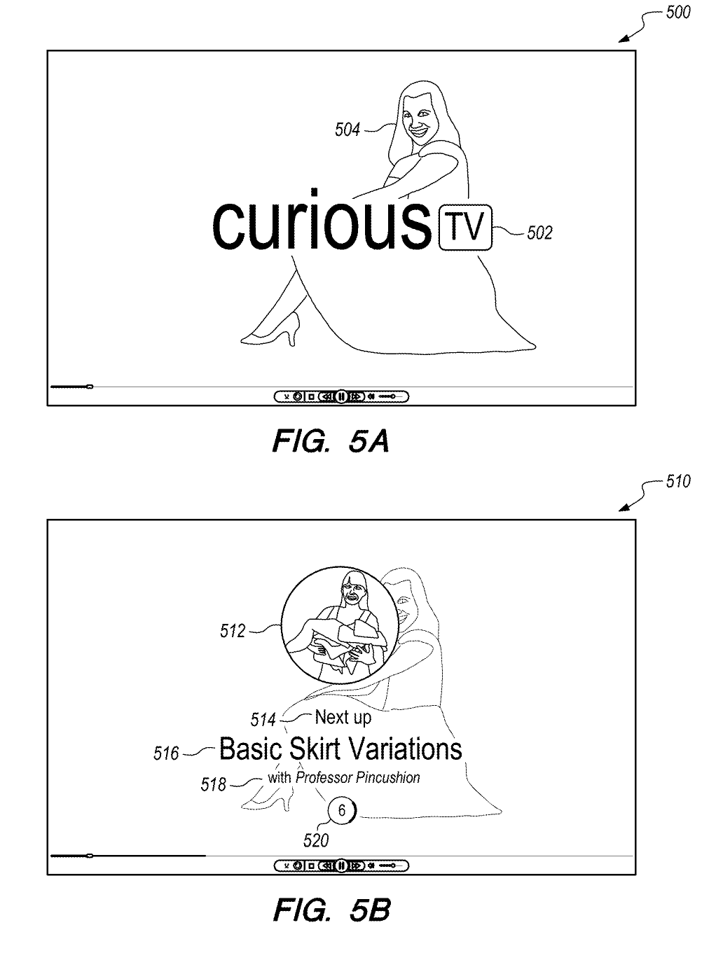

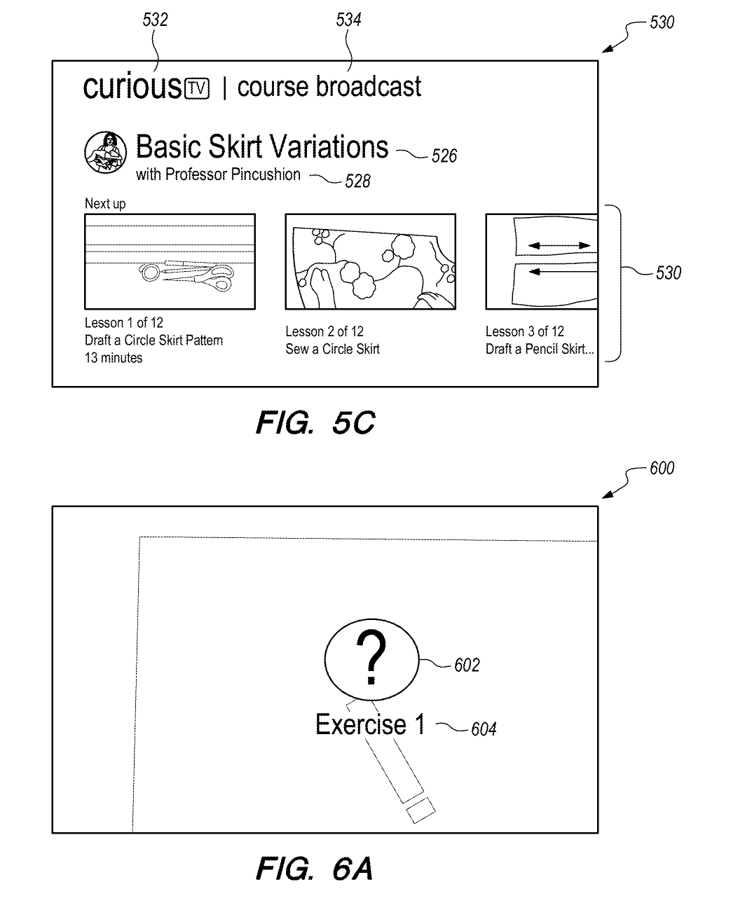

FIG. 5A, FIG. 5B, and FIG. 5C are screenshots of an animated intro transition that is positioned before a course to introduce that course in accordance with exemplary embodiments of the present invention.

In FIG. 5A, for example, the animated intro transition begins by displaying the interface illustrated by screenshot 500. Screenshot 500 shows a Curious TV logo 502, representing the assignee of the present invention. This logo is layered over a background showing the lesson teacher 504. It is noted that the intro animation template for this transition can only receive data for the Curious TV logo as well as the image background as shown at 504.

In FIG. 5B, the animated intro transition next shows the interface depicted by screenshot 510 of FIG. 5B. Here, avatar placeholder 512 is shown that displays an image of the lesson teacher; and “Next Up” 514 is then shown above the placeholder for course title 516, which is above the placeholder for teacher name 518 as shown. In this manner, data for the course here “Basic Skirt Variations” and for the teacher name, here, “Professor Pincushion” are loaded into the placeholders. An animated countdown sequence 520 that counts down from 10 to 1 before displaying the next interface is also shown.

Specifically, upon completion of that countdown, the animated intro transition proceeds to the interface illustrated by screenshot 530 of FIG. 5C. In FIG. 5C, before the first video lesson is played, logo display 532 for CuriousTV is shown along with the text “Course Broadcast” 534. The title is again shown at 536; teacher name is shown at 538, and a carousel showing clips of the lessons is shown at 540. Again, these are only the types of data that can be received in an intro animated template for an intro transition. The animated intro transition is based on the intro template.

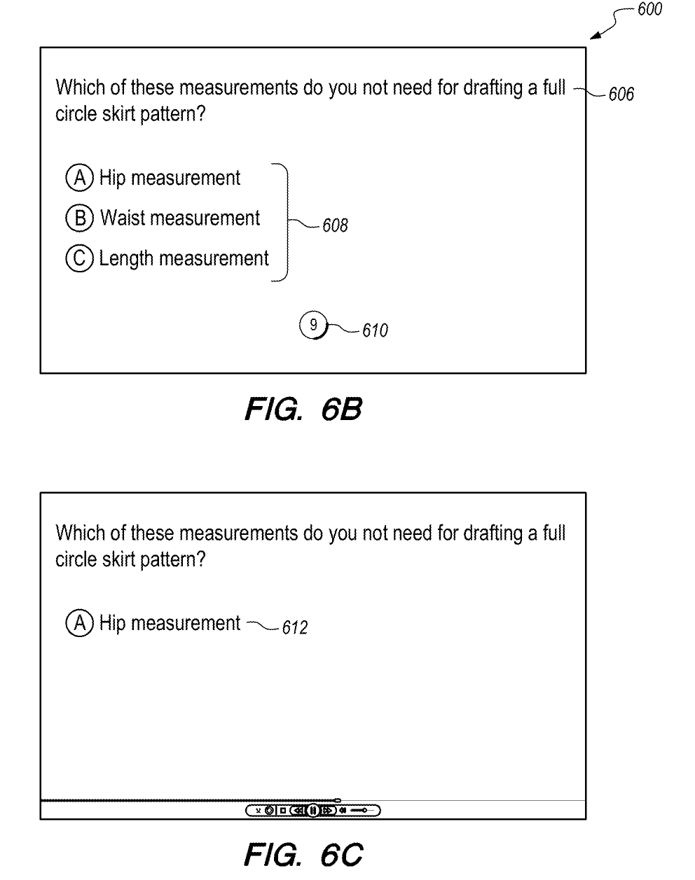

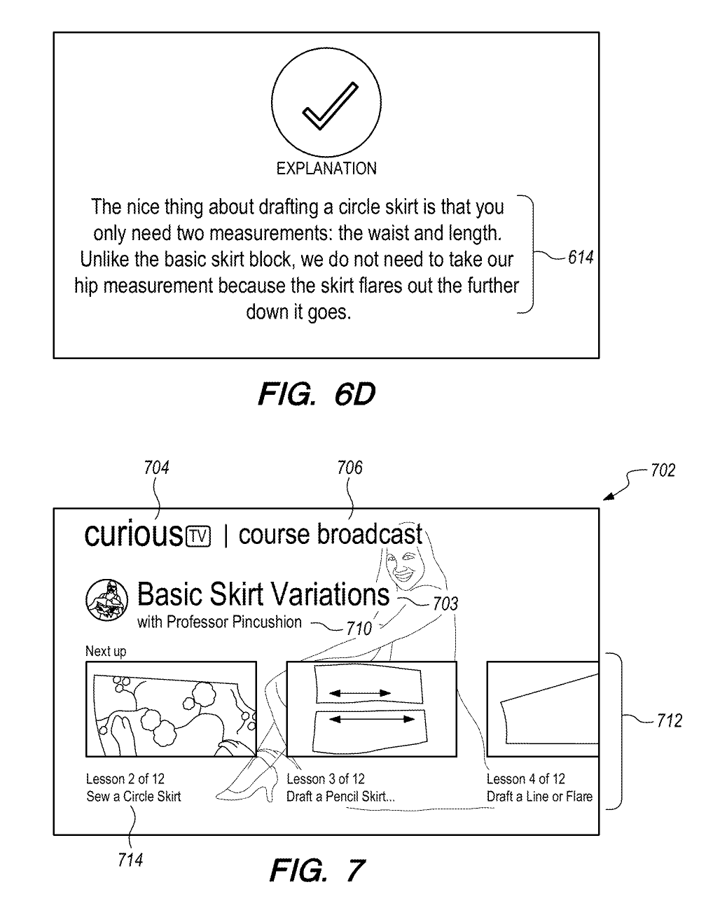

FIGS. 6A, 6B, and 6C show an animated exercise transition that is configured for and positioned after a section (or time-coded section) of a video lesson has played, in accordance with exemplary embodiments of the present invention. This transition will typically be positioned after the video lesson has started and after the animated intro transition. FIG. 6A shows a question mark 602 and the exercise(quiz) number 603—question mark 602 indicating that an exercise is about to begin and exercise 1 indicating the number of the upcoming exercise.

In FIG. 6B, the animated exercise transition is asking: “Which of these measurements do you not need for drafting a full circle skirt pattern?” As shown at 606, three options “Hip measurement, Waist measure or Length measurement” 608 are provided. Unlike the interactive files that allows mobile user 104 to select and submit an answer, the answer is simply displayed after the expiration of animated countdown timer 610 as shown by answer 612 of FIG. 6C. An explanation 614 of answer 612 is provided in FIG. 6D. The animated exercise transition is based on the exercise template.

FIG. 7 shows a screenshot of animated lesson carousel transition 702. This transition is sequenced after a first video lesson and before the second lesson begins. Thus, in courses that have more than one lesson, this animated lesson carousel transition 702 is utilized. This transition has logo 704 and an indication of course broadcast 706, title of the video 708, the teacher name 710, and a carousel showing clips of upcoming lessons 712. As can be seen here, the next lesson is lesson 2 as shown at 714. Animated lesson carousel transition 702 is based on the lesson template. Although not illustrated, a lesson section transition that is based on the lesson section template is provided in accordance with the present invention. The lesson section transition is position after a lesson section has played but before the next section is played. The lesson section transition is provided typically where a quiz or exercise transition is not provided.

FIG. 8 illustrates a screenshot of an animated course outro transition 800 in accordance with an exemplary embodiment of the present invention. As can be seen, animated course outro transition 800 has avatar 804, appreciative phrase—namely “thank you for watching” 806, the title of the lesson 808, teacher name 810, and a call to action 812. These are the only types of data that can be used in course outro animated transition 800. The course outro transition 800 is based on the course outro template.

The exemplary embodiments disclosed in this specification may be implemented in digital electronic circuitry, or in computer software, firmware, or hardware, including the structures disclosed in this specification and their structural equivalents, or in combinations of one or more of them. Exemplary embodiments of the subject matter disclosed in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. Any artificially generated signal, e.g., a machine-generated electrical, optical, or electromagnetic signal, that is generated to encode information for transmission to suitable receiver apparatus, is a propagated signal. A computer software, also referred to as a program, software, software application, script, or code can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network. Any logic and processes that are disclosed in this specification can be performed by one or more programmable processors executing one or more computer programs to perform functions by operating on input data and generating output.

The processes and logic flows can also be performed by, and apparatus can also be implemented as, special purpose logic circuitry, e.g., an FPGA (field programmable gate array) or an ASIC (application-specific integrated circuit). Examples of processors suitable for the execution of a computer program include, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few.

All forms of non-volatile memory, media and memory devices, including semiconductor memory devices, e.g., EPROM, EEPROM, and flash memory devices; magnetic disks, e.g., internal hard disks or removable disks; magneto-optical disks; and CD-ROM and DVD-ROM disks are computer-readable media suitable for storing computer program instructions and data. The processor and the memory can be supplemented by, or incorporated in, special purpose logic circuitry. To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. The exemplary embodiments of this disclosure can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet. The computing system can include clients and servers. A client and server are generally remote from each other and typically interact through a communication network. The relationship of client and server arises by virtue of computer programs running on the respective computers and having a client-server relationship to each other. While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Thus, particular embodiments of the invention have been described. Other embodiments are within the scope of the following claims. For example, the actions recited in the claims can be performed in a different order and still achieve desirable results. In addition, audio channel(s) can be processed along with the video channel(s), or the audio channel(s) can be decoupled from the video channel(s) during variable playback rate adjustments. The techniques are applicable to different types of track. A title track is such an example.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A data processing, computer-implemented method comprising:
receiving a first video content that is comprised of one or more video data files, wherein the first video content is segmented into a plurality of time-coded sections, and wherein each respective time-coded section corresponds to a section video data file that plays a key concept of the first video content,
using a plurality of templates for multiple locations in a sequence of the plurality of section video data files that are being configured for streaming, each one of the plurality of templates defining transition content layout for each one of a specific location in the sequence of section video data files; and
automatically loading transition data into each of the plurality of templates for each specific one of the multiple locations in the sequence of the plurality of section video data files to generate transition content prior to or as streaming occurs.

2. The computer-implemented method of claim 1 further comprising
generating a stream-able video sequence or file by merging the transition content and the plurality of section video data files.

3. The computer-implemented method of claim 1 wherein
automatically loading transition data into each of the plurality of templates is via a script file including instructions to load transition data into each of the plurality of templates.

4. The computer-implemented method of claim 1 further comprising using a first template for an introductory transition located before the first video content, the introductory transition comprising introductory data for the first video content.

5. The computer-implemented method of claim 1 further comprising using a second template for a testing transition located at the end of a time-coded section, the testing transition comprising data that tests concepts of the first video content.

6. The computer-implemented method of claim 1 further comprising using a third template for an outro transition located at the end of the first content, the outro transition comprising concluding credit data for the first video content.

7. The computer-implement method of claim 1 further comprising receiving a second video content that is comprised of one or more video data files, wherein the second video content is segmented into a plurality of time-coded sections, and wherein each respective time-coded section corresponds to a section video data file that plays a key concept of the second video content, and
using a fourth template for an in-between first and second video content transition that is located between the first video content and the second video content, the in-between first and second video content transition comprising notification data for the upcoming second video content.

8. The computer-implemented method of claim 1 further comprising using a fifth template a section transition located at the end of a time-coded section, the section transition comprising notification data for an upcoming time-coded section.

9. A computer program product, encoded on a non-transitory computer-readable medium, operable to cause data processing apparatus to perform operations comprising:
receiving a first video content that is comprised of one or more video data files, wherein the first video content is segmented into a plurality of time-coded sections, and wherein each respective time-coded section corresponds to a section video data file that plays a key concept of the first video content,
using a plurality of templates for multiple locations in a sequence of the plurality of section video data files that are being configured for streaming, each one of the plurality of templates defining transition content layout for each one of a specific location in the sequence of section video data files; and
automatically loading transition data into each of the plurality of templates for each specific one of the multiple locations in the sequence of the plurality of section video data files to generate transition content prior to or as streaming occurs.oncepts of the first video content.

10. The computer program product of claim 9 further comprising
generating a stream-able video sequence or file by merging the transition content and the plurality of section video data files.

11. The computer program product of claim 9 further comprising automatically loading transition data into each of the plurality of templates is via a script file including instructions to load transition data into each of the plurality of templates.

12. The computer program product of claim 9 further comprising using a first template for an introductory transition located before the first video content, the introductory transition comprising introductory data for the first video content.

13. The computer program product of claim 9 further comprising using a second template for a testing transition located at the end of a time-coded section, the testing transition comprising data that tests concepts of the first video content.

14. The computer program product of claim 9 further comprising using a third template for an outro transition located at the end of the first content, the outro transition comprising concluding credit data for the first video content.

15. The computer program product of claim 9 further comprising receiving a second video content that is comprised of one or more video data files, wherein the second video content is segmented into a plurality of time-coded sections, and wherein each respective time-coded section corresponds to a section video data file that plays a key concept of the second video content, and
using a fourth template for an in-between first and second video content transition that is located between the first video content and the second video content, the in-between first and second video content transition comprising notification data for the upcoming second video content.

16. The computer program product of claim 9 further comprising using a fifth template a section transition located at the end of a time-coded section, the section transition comprising notification data for an upcoming time-coded section.
